(19) United States
(12) Patent Application Publication
(10) Pub. No.: US 2012/0169674 A1
(43) Pub. Date: Jul. 5, 2012

(54) INPUT DEVICE AND INPUT SYSTEM

(75) Inventor: Kayato Sekiya, Minato-Ku (JP)

(73) Assignee: NEC CORPORATION, Tokyo (JP)

(21) Appl. No.: 13/395,894

(22) PCT Filed: Aug. 20, 2010
(86) PCT No.: PCT/JP2010/064537

§ 371 Date: Mar. 14, 2012

(30) Foreign Application Priority Data
Sep. 15, 2009 (JP) 2009-212711

(51) Int. Cl. G06F 3/033

(52) U.S. Cl. 345/179

(57) ABSTRACT

It becomes possible to directly detect ink distribution on a surface of a transparent or semitransparent marker board. An input device includes a light source unit which injects light into a transparent or semitransparent paintable body in a manner the light is guided inside the paintable body and a detection unit which detects light diffused out of the paintable body by applying painting substance on a surface of the paintable body.

### TECHNICAL FIELD

The present invention relates to an input device and an input system which mechanically read information on letters, figures and the like drawn on a transparent or semitransparent marker board.

### BACKGROUND ART

A white board (marker board), which allows for many-time repeated drawing and erasing, is widely used at classes in school and meetings in companies and the like. Further, in recent years, a digital white board capable of converting contents drawn on the white board into electronic data also has grown popular. Using such a digital white board, achieved are various high value-added functions such as projection on a big screen, distribution to a nearby screen, sharing between remote bases, of digitized information

Alternately, a marker board employing a transparent drawing surface is attracting much attention recently. It is because the transparent marker board has merits such as high compatibility with architectural designs.

Another merit of employing a transparent board surface is that the user becomes able to pay attention easily to visual information (surroundings information) other than drawn pictures and letters.

According to patent document 1, for example, a system where a speaker can make board writing without having his back to the audience, by using a transparent marker board, is achieved. Patent document 1 discloses a technology in which coordinates of a marker pen on a board are detected at every moment using infrared and ultrasonic signals, and a locus drawn by the marker pen is converted to electronic data.

The system described in patent document 1 is composed of a marker pen equipped with built-in infrared and ultrasonic transmitters, a receiver unit, a coordinate calculation unit for calculating a coordinate of a marker pen, and a board writing image generation unit for generating an image of board writing. The receiver unit includes one built-in infrared receiver and two built-in ultrasonic receivers. The two ultrasonic receivers are disposed at positions each separated from the other. When a tip of the marker pen touches the board face, the infrared and ultrasonic transmitters which are built-in in the pen generates infrared and ultrasonic signals simultaneously. While the infrared signal is transmitted in a moment at the velocity of light, the ultrasonic signal reaches the receivers slowly, compared the infrared signal, at the velocity of sound. Further, because the two ultrasonic receivers are separated from each other, the ultrasonic signal reaches each of the receivers at a time which is different between the two receivers. From these differences in signal arrival time between the receivers, the coordinate calculation unit calculates an x and y coordinate of the marker pen, using the principle of triangulation. Temporally repeating this coordinate detection, the board writing image generation unit converts loci of the marker pen, that is, pictures and letters drawn on the board, into electronic data.

Non-patent document 1 discloses another technology for converting contents drawn on a marker board into electronic data. Non-patent document 1 discloses a technology in which pictures and letters on a marker board are captured in a video image by the use of a camera.

A system described in non-patent document 1 is installed above a marker board, and is configured with a movable-type camera whose capturing direction can be controlled freely and an image processing device. The camera captures a board surface entirely, changing its capturing direction. The image processing device corrects distortion in the captured image, and stitches a plurality of images to generate a large image in which the whole marker board is captured.

[Citation List]

[Patent Literature]

[patent document 1] Japanese Patent Application Laid-Open No. 2005-208952

[Non-patent literature]

[non-patent document 1] Eric Saund, “Bringing the Marks on a Whiteboard to Electronic Life”, Second International Workshop on Cooperative Buildings, Integrating Information, Organization and Architecture, pp 69-78, 1999.

[non-patent document 2] Z. Zhang, “A flexible new technique for camera calibration”, IEEE Transactions on Pattern Analysis and Machine Intelligence, Vol. 22, Issue 11, pp 1330-1334, 2000.

[non-patent document 3] Richard Hartley, “Multiple View Geometry in Computer Vision”, Cambridge University Press, pp 32-37, 2000.

### SUMMARY OF INVENTION

Technical Problem However, the system described in patent document 1 cannot convert drawn pictures and letters into electronic data accurately. Further, the system described in non-patent document 1 cannot discriminate pictures and letters drawn on a transparent or semitransparent marker board from background.

It is because the systems described in patent document 1 and non-patent document 1 do not have a function to detect directly an adhering state of ink on a surface of a transparent or semitransparent marker board.

Accordingly, the objective of the present invention is to provide an input device capable of detecting directly an adhering state of ink on a surface of a transparent or semitransparent marker board.

Solution to Problem

In order to achieve the above-mentioned objective, an input device of the present invention comprises: a light source unit which injects light into a transparent or semitransparent paintable body in a manner the light is guided inside said paintable body; and a detection unit which detects light diffused out of said paintable body by applying painting substance on a surface of said paintable body.

In order to achieve the above-mentioned objective, an input system of the present invention comprises: an input device comprising: a paintable body which is transparent or semitransparent and is capable of guiding light inside, a light source unit which injects light in a manner the light is guided inside said paintable body, and a detection unit which detects light diffused out of said paintable body by applying painting substance on a surface of said paintable body; a recording unit which is connected to said input device and stores a position of said painting substance as electronic data, on the basis of a detection result from said detection unit; and a display unit which displays said position of said painting substance which is stored in said recording unit.

In order to achieve the above-mentioned objective, an input method of the present invention comprises: injecting light into a transparent or semitransparent paintable body in a manner the light is guided inside said paintable body; and detecting light diffused out of said paintable body by applying painting substance on a surface of said paintable body.

In order to achieve the above-mentioned objective, an input program recorded in a strage medium of the present invention enables a computer to execute a step of injecting light into a transparent or semitransparent paintable body capable of guiding light inside; and a step of detecting light diffused out of said paintable body from painting substance being applied on a surface of said paintable body.

Advantageous Effect of Invention

According to an input device of the present invention, it is possible to detect directly an adhering state of ink on a surface of a transparent or semitransparent marker board.

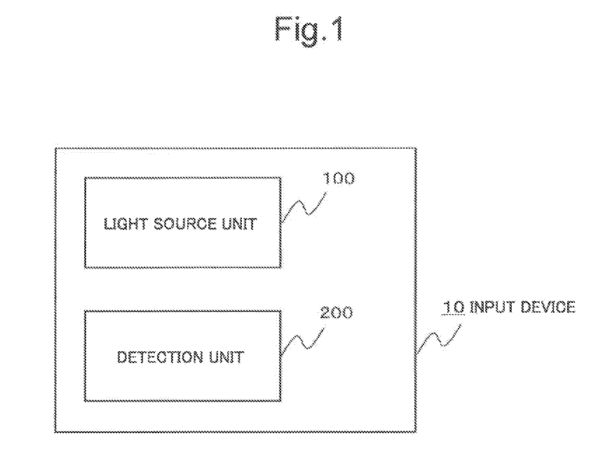

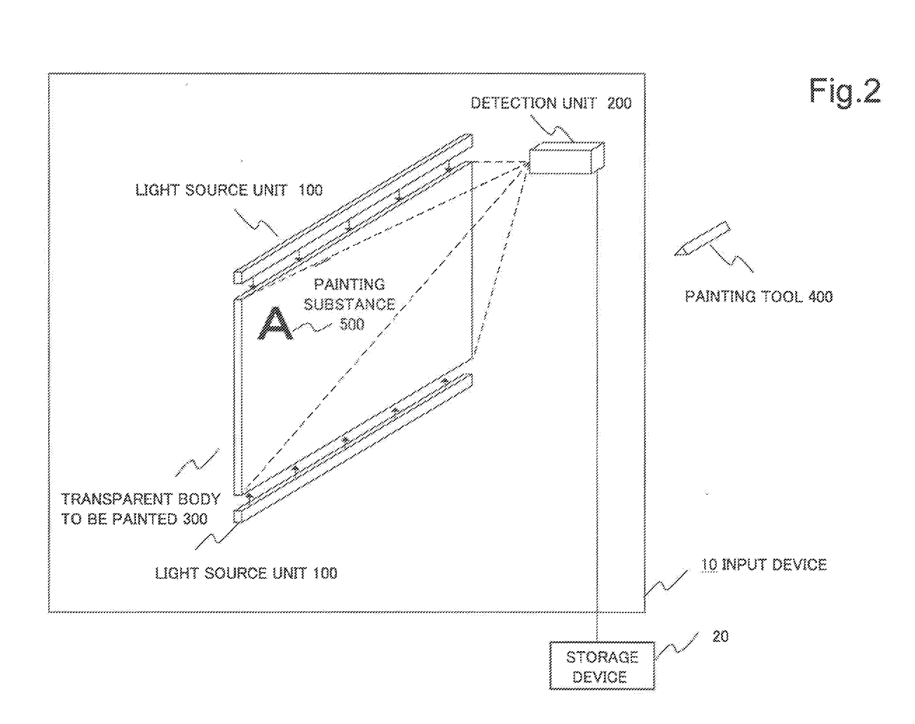

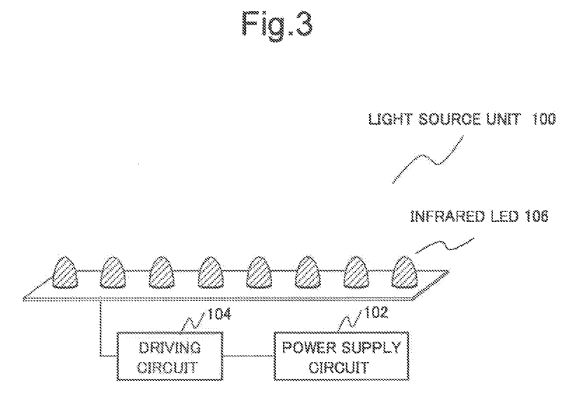

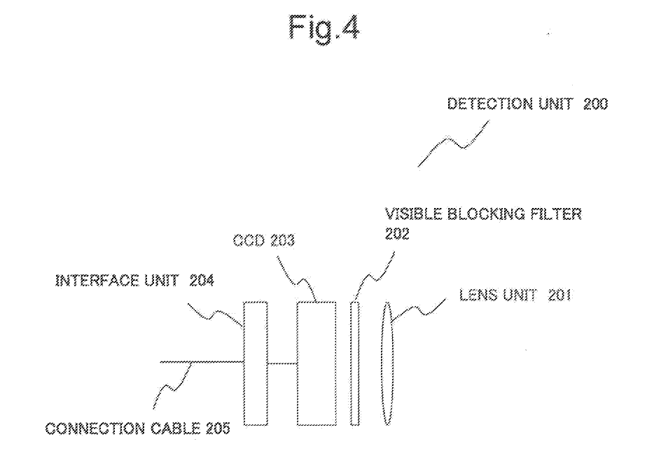

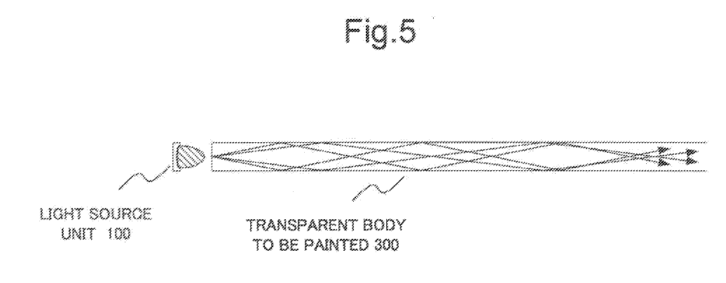

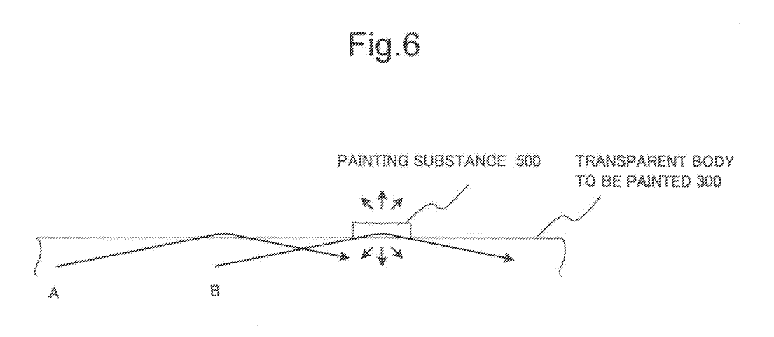

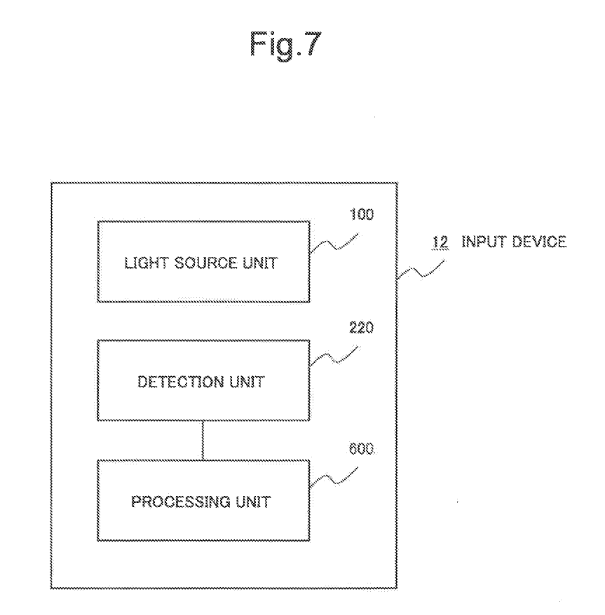

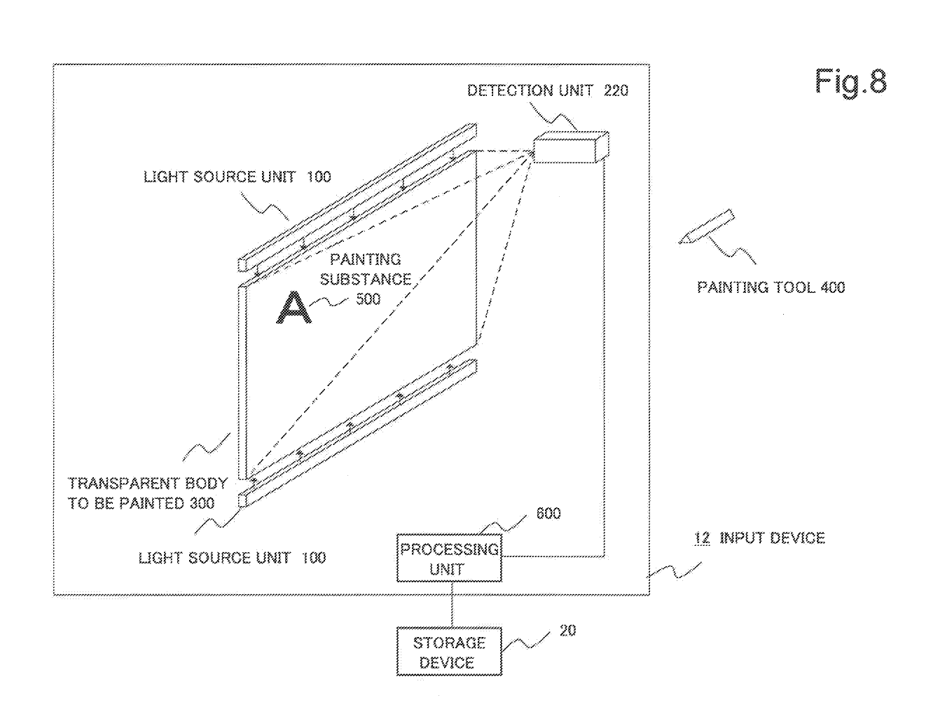

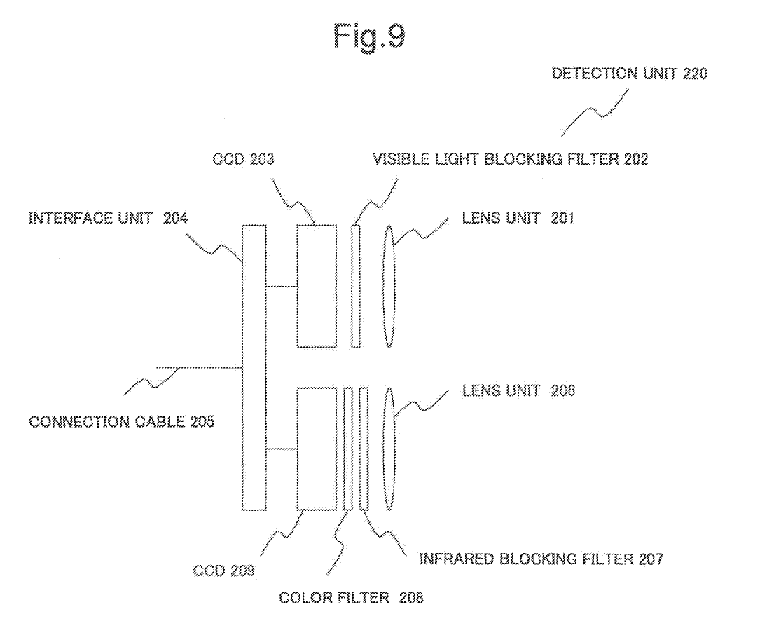

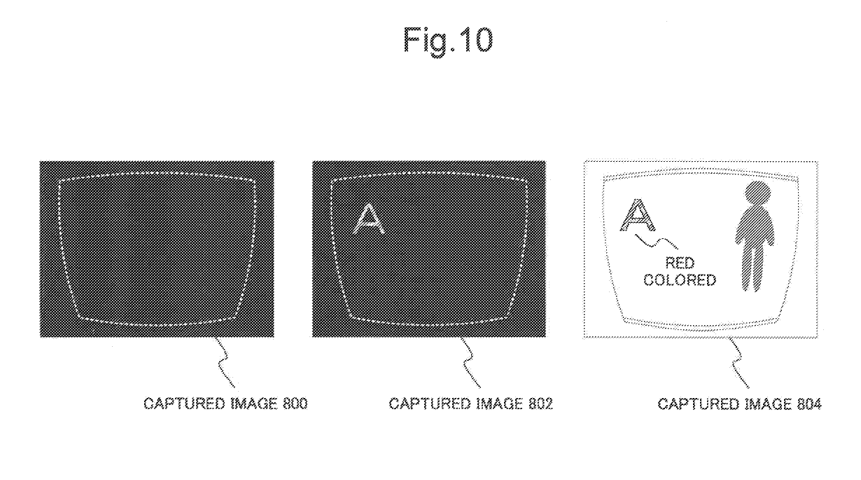

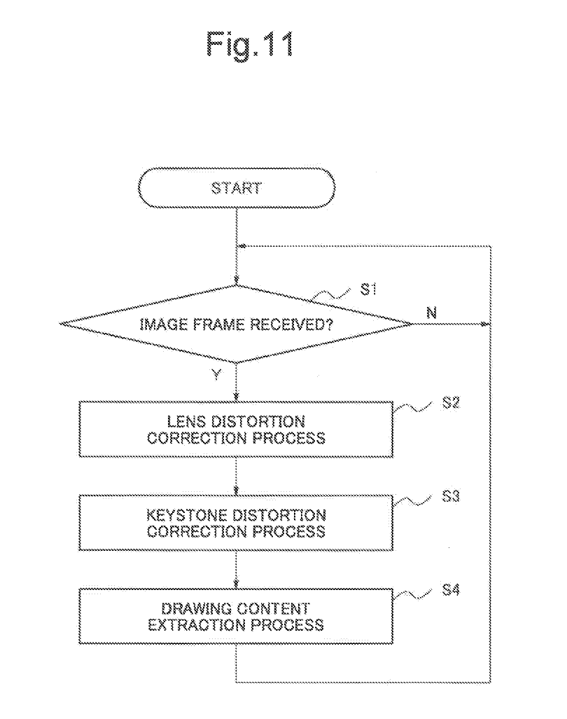

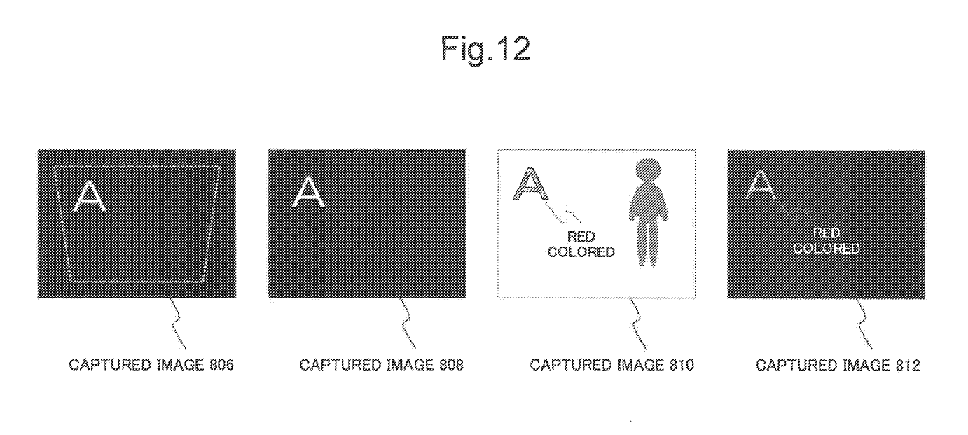

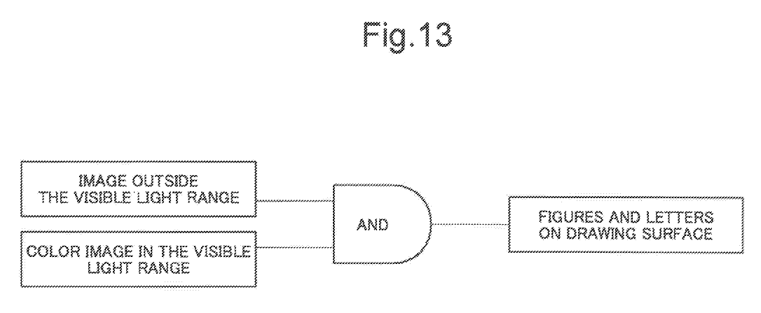

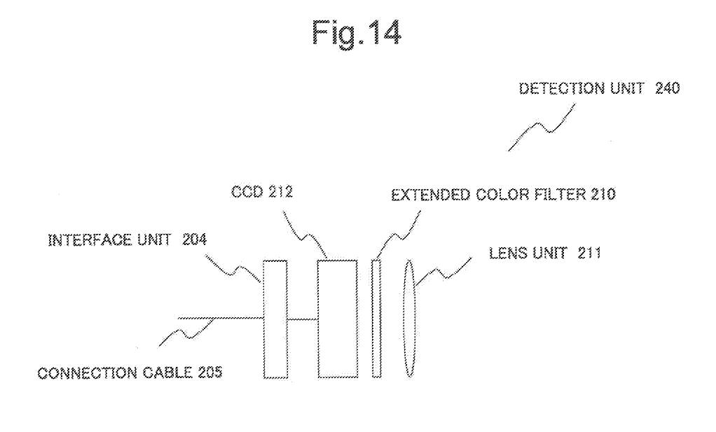

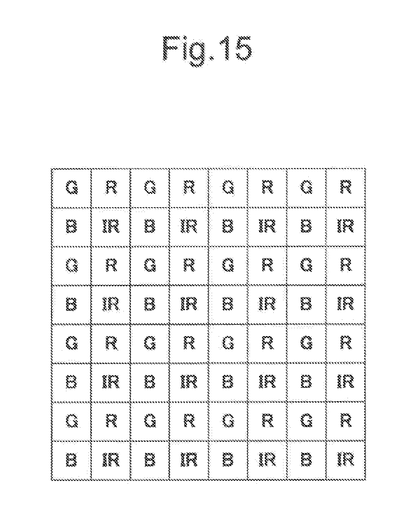

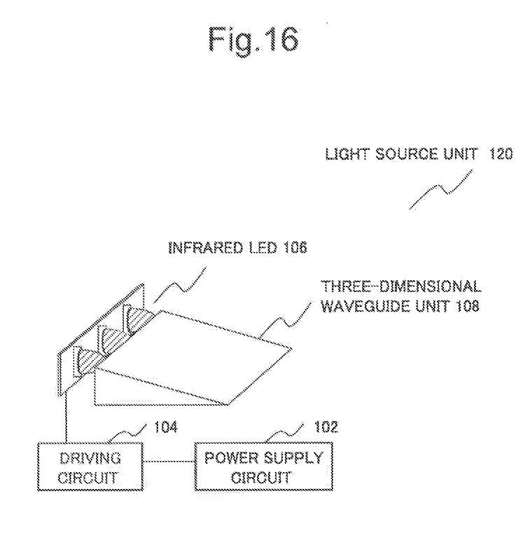

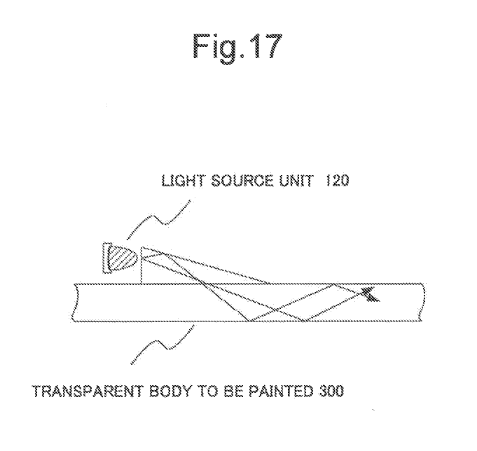

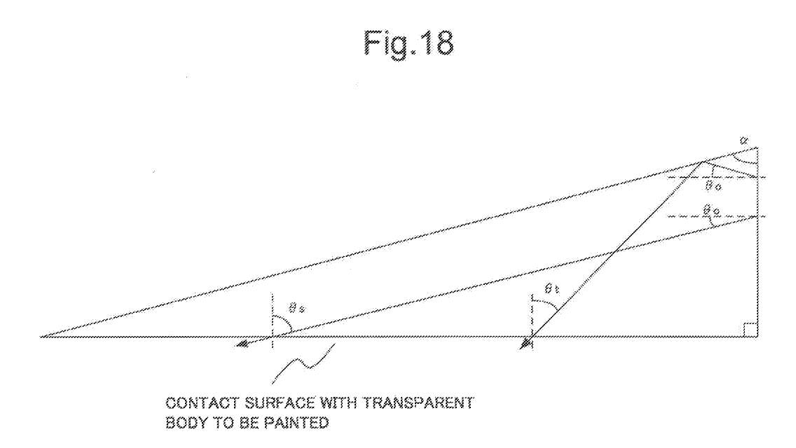

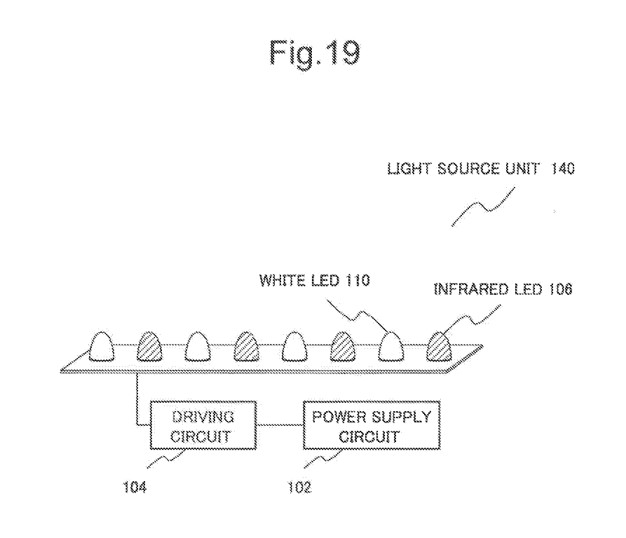

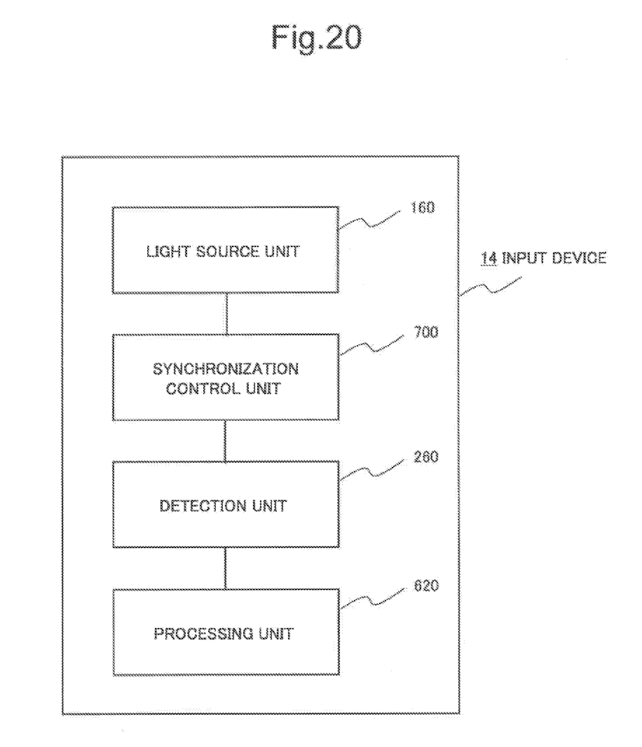

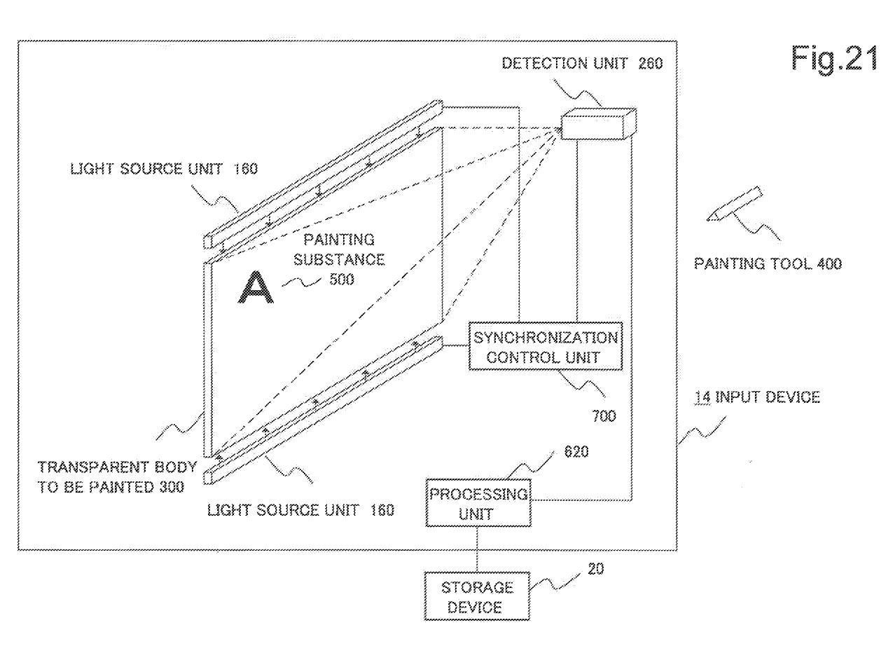

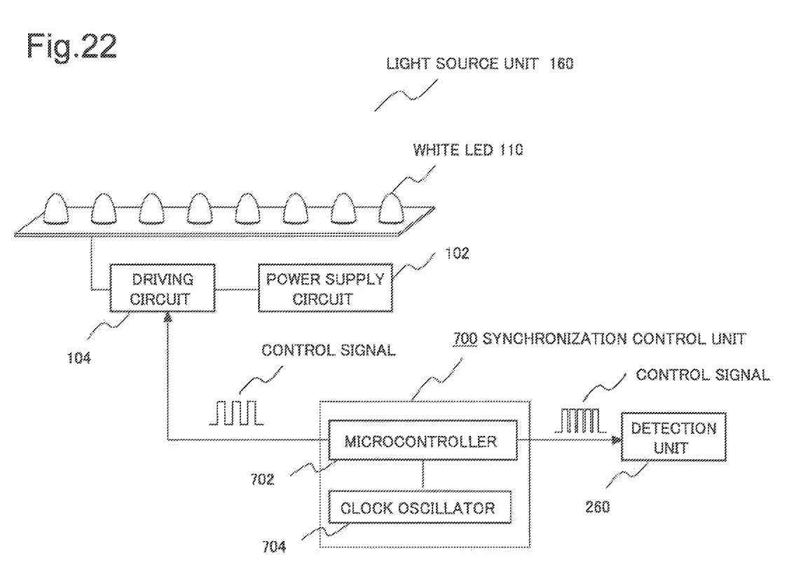

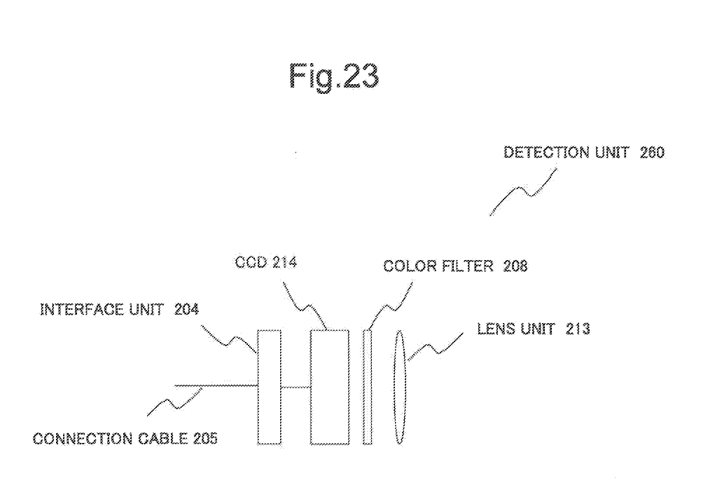

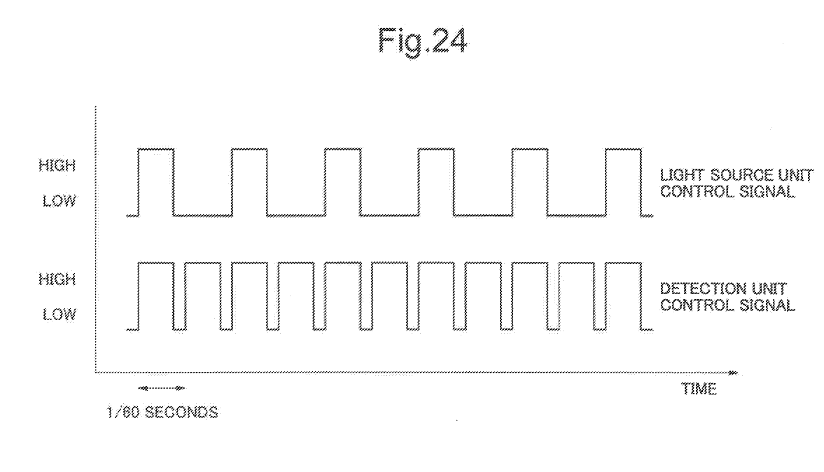

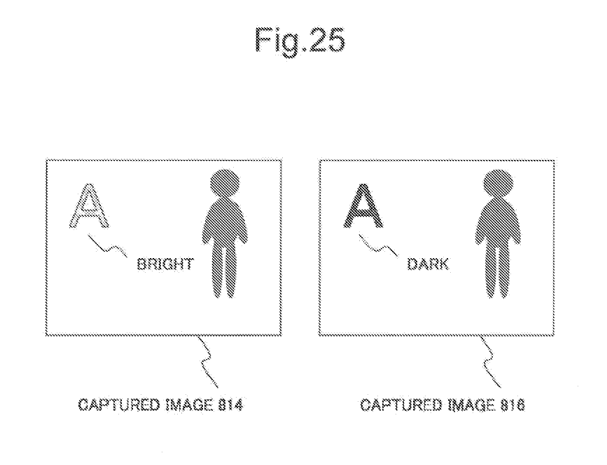

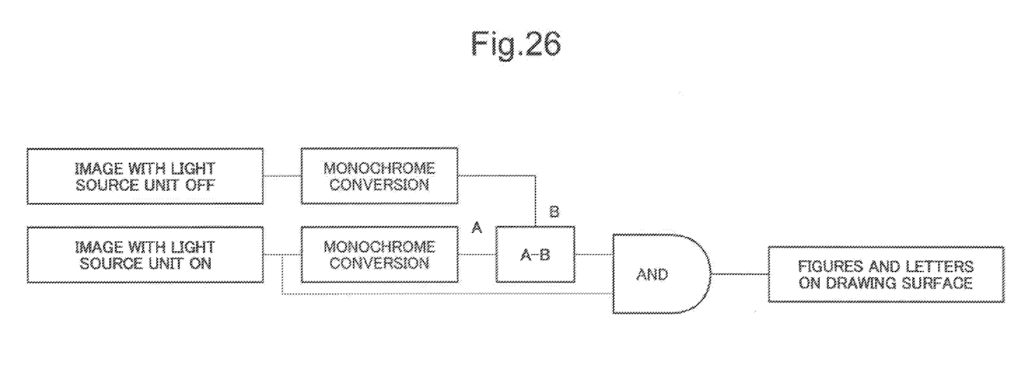

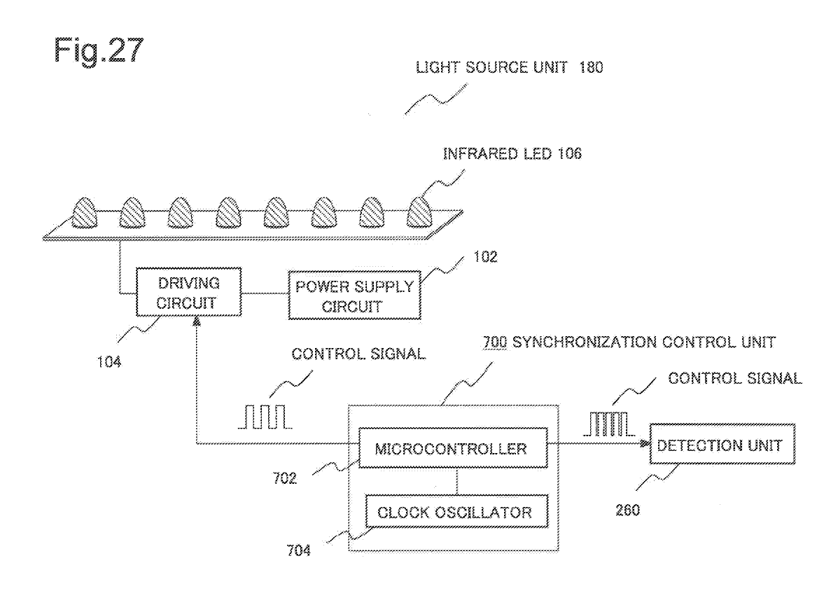

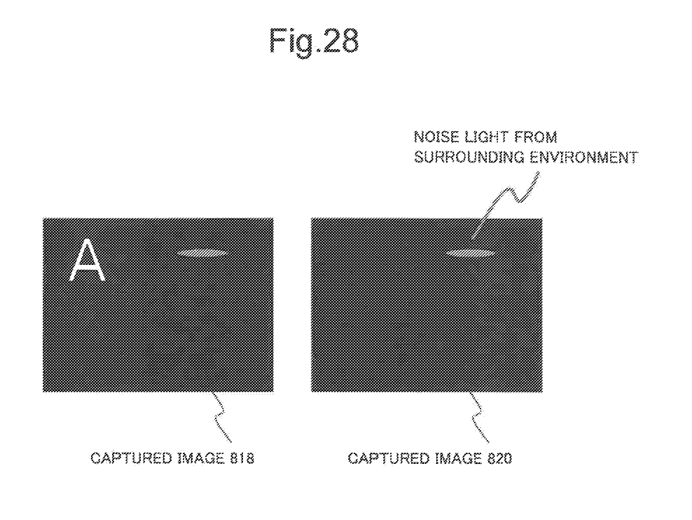

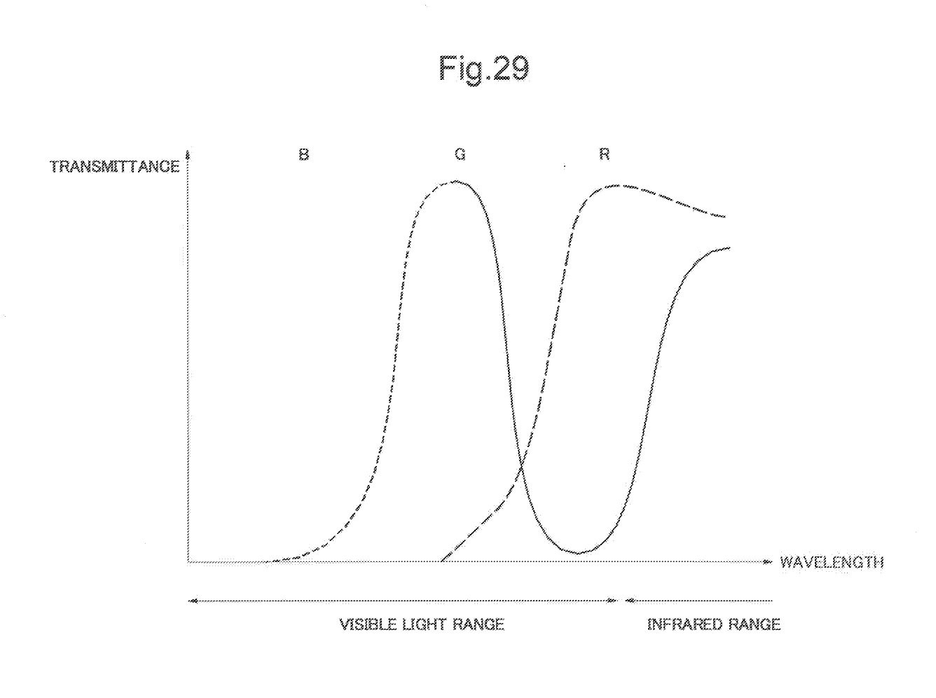

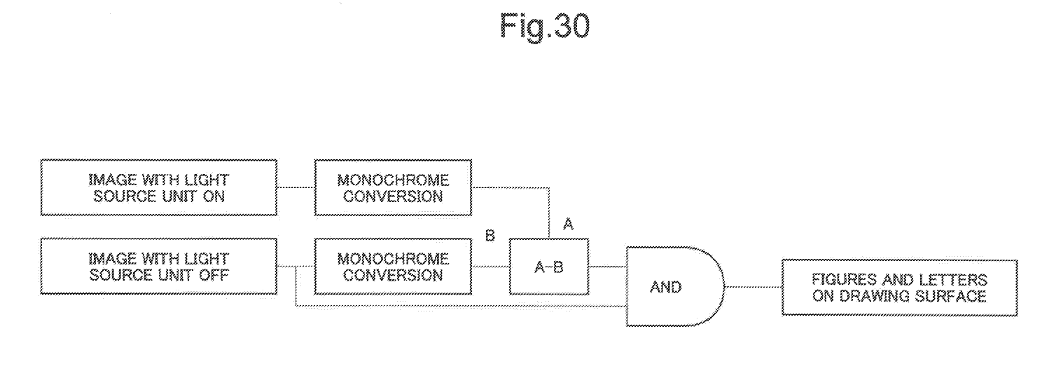

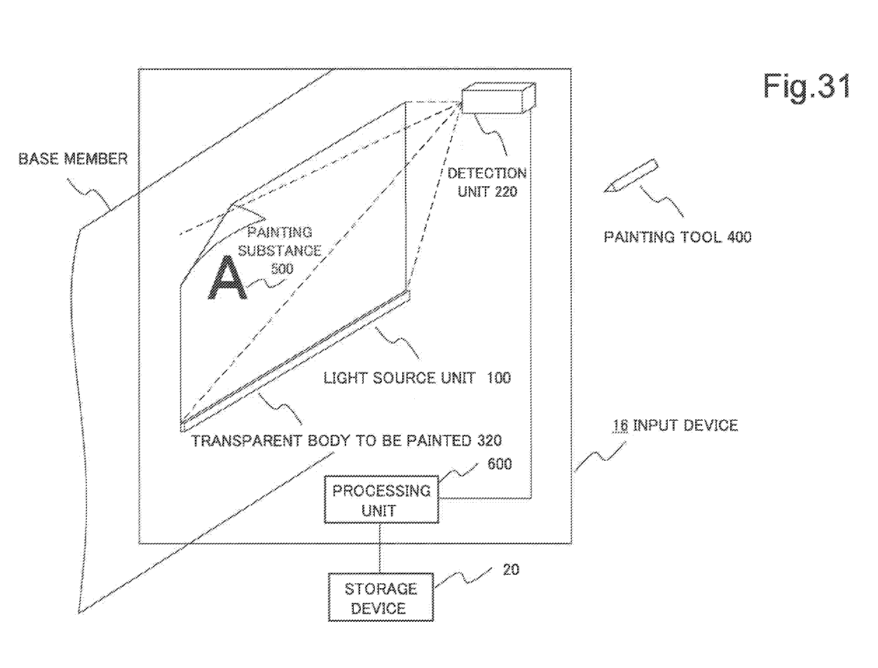

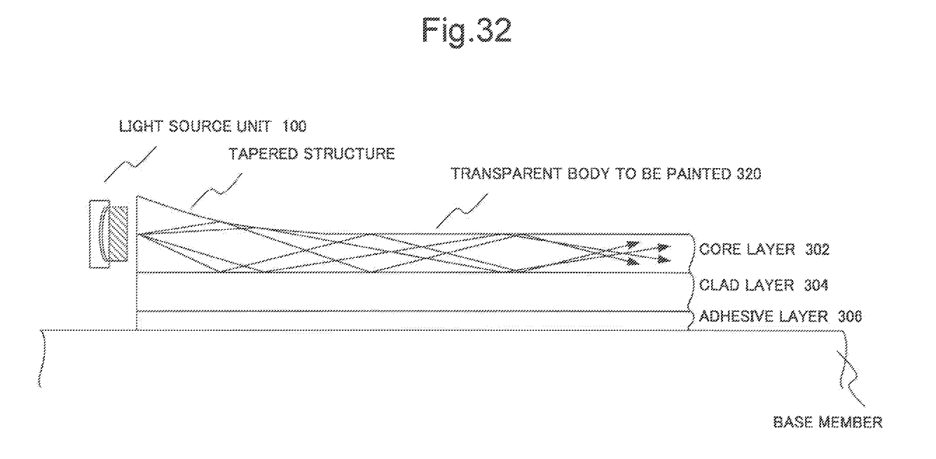

### BRIEF DESCRIPTION OF DRAWINGS

[FIG. 1] a block diagram of an input device according to a first exemplary embodiment of the present invention.

[FIG. 2] a configuration diagram of an input device according to the first exemplary embodiment of the present invention.

[FIG. 3] a diagram showing an example of a light source unit 100.

[FIG. 4] a configuration diagram of a detection unit 200 according to the first exemplary embodiment of the present invention.

[FIG. 5] a diagram for illustrating guiding of light in a case where painting substance 500 is not applied on a transparent paintable body 300.

[FIG. 6] a diagram for illustrating guiding of light in a case where painting substance 500 is applied on a transparent paintable body 300.

[FIG. 7] a block diagram of an input device according to a second exemplary embodiment of the present invention.

[FIG. 8] a configuration diagram of an input device according to the second exemplary embodiment of the present invention.

[FIG. 9] a configuration diagram of a detection unit 220 according to the second exemplary embodiment of the present invention.

[FIG. 10] a diagram showing an example of an image captured by the detection unit 220.

[FIG. 11] a flow chart showing an example of image processing performed by a processing unit 600.

[FIG. 12] a diagram showing a result of image processing performed by the processing unit 600.

[FIG. 13] a diagram for illustrating a drawing content determination process performed by the processing unit 600 in the second exemplary embodiment of the present invention.

[FIG. 14] a diagram showing an example of a configuration of a detection unit 240 according to a third exemplary embodiment.

[FIG. 15] a configuration diagram of an extended color filter 210.

[FIG. 16] a diagram showing an example of a configuration of a light source unit 120 according to a fourth exemplary embodiment.

[FIG. 17] a diagram schematically illustrating how light emitted by the light source unit 120 according to the fourth exemplary embodiment is guided into the inside of a transparent board and propagates being confined inside the board.

[FIG. 18] a diagram showing an example of a section of a three-dimensional waveguide unit 108.

[FIG. 19] a diagram showing an example of a configuration of a light source unit 140 of a fifth exemplary embodiment.

[FIG. 20] a block diagram of an input device according to a sixth exemplary embodiment of the present invention.

[FIG. 21] a configuration diagram of an input device according to the sixth exemplary embodiment of the present invention.

[FIG. 22] a diagram specifically showing a light source unit 160, a detection unit 260 and a synchronization control unit 700 according to the sixth exemplary embodiment of the present invention.

[FIG. 23] a configuration diagram of the detection unit 260 according to the sixth and an eighth exemplary embodiment of the present invention.

[FIG. 24] a diagram representing a square wave pulse of a control signal outputted by the synchronization control unit 700.

[FIG. 25] a diagram showing an example of each of images respectively captured when the light source unit 160 and a light source unit 180 are on and off.

[FIG. 26] a diagram for illustrating a drawing content determination process performed by a processing unit 620 in the sixth exemplary embodiment of the present invention.

[FIG. 27] a diagram specifically showing the light source unit 180, the detection unit 260 and a synchronization control unit 700 according to a seventh exemplary embodiment of the present invention.

[FIG. 28] a diagram showing an example of each of images respectively captured when the light source unit 180 according to the seventh exemplary embodiment of the present invention is on and off.

[FIG. 29] a diagram for illustrating transmittance of a color filter 208.

[FIG. 30] a diagram for illustrating a drawing content determination process performed by a processing unit 660 in a eighth exemplary embodiment of the present invention.

[FIG. 31] a configuration diagram of an input device 16 according to a ninth exemplary embodiment of the present invention.

[FIG. 32] a cross-sectional view of a transparent paintable body 320 according to the ninth exemplary embodiment of the present invention.

### DESCRIPTION OF EMBODIMENTS

First, in order to ease understanding of the present invention, background and outline of the present invention will be described.

Relating to the present invention, there is a technology in which coordinates of a marker pen on a board are detected at every moment and a locus drawn by the marker pen is converted into electronic data. However, in a technology employed there for detecting coordinates of a pen on a board, pictures and letters drawn on the board are estimated from a movement history of the pen, and hence there may be a discrepancy between actual pictures and letters drawn on the board and their electronic data. For example, in such a related technology, when the user erased pictures or letters drawn on the board touching them by mistake, the change cannot be reflected in corresponding electronic data. Further, in such a related technology, because information on thickness and blurring of lines is also lost, pictures and letters drawn on the board cannot be reproduced accurately.

There is another technology related to the present invention in which pictures and letters on a marker board are captured in a video image by the use of a camera. However, when such a related technology is applied to a transparent marker board, persons and objects behind the board are also captured in addition to pictures and letters on the marker board. Accordingly, it becomes difficult for the user to discriminate between pictures and letters on the marker board and background of the board. In actual space, based on depth information of the sense of sight, users recognize pictures and letters on a marker board discriminately from information on behind-the-board. However, when they are captured with a camera, rays of light in space are projected onto a two-dimensional plane (imaging device), and thus the depth information is lost. Accordingly, it becomes difficult for the user to recognize the pictures and letters discriminately from the background.

Further, situation is said to be the same when the marker board is not perfectly transparent but is semitransparent.

In this aspect, a handwriting input device according to the present invention enables accurate conversion of figures and letters drawn on a maker board to electronic data, by detecting directly a state of ink distribution on the marker board surface. Further, a handwriting input device according to the present invention enables detection of pictures and letters drawn on a transparent or semitransparent marker board discriminately from the background, by detecting directly a state of ink distribution on the marker board surface.

In the following, exemplary embodiments of the present invention will be described.

### First Exemplary Embodiment

FIG. 1 is a block diagram of an input device 10 according to a first exemplary embodiment of the present invention. As shown in FIG. 1, the input device 10 according to the first exemplary embodiment of the present invention comprises a light source unit 100 and a detection unit 200.

The light source unit 100 injects light into a paintable body, which is transparent or semitransparent and capable of guiding light inside, in a manner which enables the light to be guided inside the paintable body.

The detection unit 200 detects light which is diffused outside the paintable body by applying painting substance on a surface of the paintable body.

FIG. 2 is a configuration diagram of the input device 10 according to the first exemplary embodiment of the present invention. As shown in FIG. 2, specifically, the input device 10 according to the first exemplary embodiment of the present invention is connected to a storage device 20, and it comprises a transparent paintable body 300 which painting substance 500 is applied to or removed from by a painting tool 400, a light source unit 100 and a detection unit 200.

The transparent paintable body 300 is a transparent flat plate to and from which painting substance can be applied and removed. For example, the transparent paintable body 300 may be a resin board of acrylic and the like.

The painting tool 400 is a writing tool having a structure to apply painting substance 500 contained therein to the transparent paintable body 300. The painting tool 400 may be a container of a felt-tip pen such as a white board marker.

The painting substance 500 is a substance which can be applied to and wiped from the transparent paintable body 300. The painting substance 500 contains, as an ingredient, substance which diffuses light in the wavelength range of light emitted by the light source unit 100. For example, when light emitted by the light source unit 100 is infrared light, the painting substance 500 can be an ink of a general white board marker.

The light source unit 100 injects light in a manner where the light is guided from a side surface of the transparent paintable body 300. In this exemplary embodiment, the light is light outside the visible light range. For example, the light source unit 100 injects infrared light into the inside of the transparent paintable body 300. As shown in FIG. 3, the light source unit 100 comprises one or more infrared light emitting diodes (LEDs) 106 which are arranged in a line and driven by a power supply circuit 102 and a driving circuit 104. Here, the light source unit 100 may be arranged at one side or a plurality of sides of the transparent paintable body 300. In FIG. 2, the light source unit 100 is arranged at the top and bottom sides of the transparent paintable body 300.

The detection unit 200 detects light which is diffused outside the paintable body 300 by the painting substance 500 adhering a surface of the paintable body 300. That is, the detection unit 200 photographs the transparent paintable body 300 in the wavelength range of the light emitted by the light source unit 100. For example, the detection unit 200 may be a camera equipped with a semiconductor image sensor. The semiconductor image sensor may be a Charge Coupled Device (CCD) image sensor. Alternatively, the semiconductor image sensor may be a complementary metal oxide semiconductor (CMOS) image sensor. In FIG. 2, shown is an example where the detection unit 200 is arranged on the side, of the transparent paintable body 300, where the painting substance 500 is applied (front side). The detection unit 200 may be arranged on the side opposite to the side having the painting substance 500 applied (rear side). The storage device 20 stores input results obtained by the input device 10. The storage device 20 may be, for example, a primary or a secondary storage device of a PC.

Next, detailed description will be given of a configuration of the detection unit 200 according to the first exemplary embodiment of the present invention.

FIG. 4 is a configuration diagram of the detection unit 200 according to the first exemplary embodiment of the present invention. The detection unit 200 may be configured in any manner which enables detection of light diffused by painting substance. In the present exemplary embodiment, as shown in FIG. 4, the detection unit 200 comprises a lens unit 201, a visible light blocking filter 202, a CCD 203 and an interface unit 204, and is connected to a connection cable 205.

The CCD 203 photoelectrically converts brightness of light entering it via the lens unit 201 and the visible light blocking filter 202 to a quantity of electric charge. The CCD 203 has sensitivity in the wavelength range of light emitted by the light source unit 100. When the light source unit 100 emits near infrared light with a wavelength of about 850-950 nm, the CCD 203 may be a visible light CCD module generally available in the market.

The lens unit 201 condenses entering light and guides it to the CCD 203. The lens unit 201 may be a generally available camera lens.

The visible light blocking filter 202 eliminates most of visible components of the light guided by the lens unit 201 to the CCD 203. The visible light blocking filter 202 may be, for example, a multilayer interference filter.

Under the configuration described above, the CCD 203 capture an image in a light range outside the visible range (infrared range).

The interface unit 204 performs analog-to-digital conversion of electric signals inputted from the CCD 203 and transforms the signals into a predetermined transfer format. As the transfer format, standards such as CameraLink and IEEE1394 may be used, for example.

Next, operation of the input device 10 in FIG. 2 will be described in detail with reference to drawings.

The light source unit 100 injects light outside the visible light range from a side surface of the transparent paintable body 300.

The detection unit 200 continually captures images in the invisible light range of the transparent paintable body 300 and painting substance adhering to it. The detection unit 200 captures the images at a rate of, for example, 60 frames per second.

FIG. 5 is a diagram for illustrating guiding of light in a case where the painting substance 500 is not applied on the transparent paintable body 300. As shown in FIG. 5, when the painting substance 500 is not applied on the transparent paintable body 300, light emitted from the light source unit 100 is totally reflected at surfaces of the transparent paintable body 300 and thus guided being confined inside. In this case, light emitted from the light source unit 100 does not reach the detection unit 200. Accordingly, images captured by the detection unit 200 become almost entirely black images.

Next, description will be given of a case where the painting substance 500 is applied on the transparent paintable body 300. Although a painting tool 400 like a white board marker is shown in FIG. 2, a painting tool is not limited to a marker. The painting tool 400 may be, for example, a rubber stamp inked with the painting substance 500.

FIG. 6 is a diagram for illustrating guiding of light in a case where the painting substance 500 is applied on the transparent paintable body 300. As described above, light outside the visible light range emitted from the light source unit 100 is totally reflected at surfaces of the transparent paintable body 300. At that time, as indicated with A in FIG. 6, a slight portion of the light leaks out from the transparent paintable body 300 to the air. This leak portion of light is called as an evanescent wave. When the painting substance 500 is applied on the transparent paintable body 300, the evanescent wave optically couples with the painting substance 500, and thus is diffused outside the transparent paintable body 300 as indicated with B in the same figure. A portion of the diffused light reaches the detection unit 200.

That is, the detection unit 200 detects only the light outside the visible light range diffused from areas where the painting substance 500 is applied. Accordingly, areas where the painting substance 500 is applied, that is, pictures and letters drawn on the transparent paintable body 300 are photographed on an image captured by the detection unit 200. The detection unit 200 outputs captured images to the storage device 20.

The storage device 20 records images outputted from the detection unit 200 as a motion picture continuously, or as still images at the times specified by the user.

As has been described above, according to the input device of the first exemplary embodiment, as light outside the visible light range emitted from the light source unit 100 is diffused out at positions where the painting substance 500 is applied, the detection unit 200 can directly detect a state of ink distribution on the marker board surface.

Further, even if the user erased pictures and letters drawn on the board touching them by mistake, the change of a distribution state of the painting substance 500 is detected on the next captured image. Accordingly, there occurs no discrepancy between electronic data and actual pictures and letters drawn on the board.

Further, as a state of application of the painting substance 500 is detected as an image two-dimensionally, information on thickness, blurring and the like of a line can be accurately reproduced depending on a resolution of the detection unit 200.

Although the transparent paintable body 300 has been assumed to be made of a body of extremely high transparency in the description given above, the present invention can be used also when a paintable body is semitransparent. Also in such a case where a semitransparent paintable body is used, obtained are the merits such as that the user can pay attention easily to surroundings information other than drawn pictures and letters, similarly to the case of highly transparent paintable body.

### Second Exemplary Embodiment

FIG. 7 is a block diagram of an input device 12 according to a second exemplary embodiment of the present invention. FIG. 8 is a configuration diagram of the input device 12 according to the second exemplary embodiment of the present invention. As shown in FIGS. 7 and 8, the input device 12 is different from the input device 10 according to the first exemplary embodiment in that it further comprises a processing unit 600. In addition, in the input device 12, a configuration of a detection unit is different compared to the first exemplary embodiment.

A detection unit 220 according to the second exemplary embodiment detects light diffused outside a paintable body by applying painting substance on a surface of the paintable body. In the present exemplary embodiment, for processing in a processing unit 600, the detection unit 220 captures a color image in the visible light range in addition to an image outside the visible light range.

On the basis of the detection results obtained by the detection unit 220, the processing unit 600 determines an area where the painting substance 500 is applied and its color.

The processing unit 600 receives the two images of the transparent paintable body 300 captured by the detection unit 220. Based upon the received images, the processing unit 600 performs a determination process of an area where the painting substance 500 is applied and its color. Details of the determination process performed by the processing unit 600 will be described later. In advance of the determination process, the processing unit 600 performs image processing including brightness adjustment and distortion correction. Then the processing unit 600 outputs the above-mentioned processing results to the storage device 20. The processing unit 600 may be, for example, a general personal computer (PC) which is equipped with interfaces for connecting with external devices and executes a general-purpose operating system, driver software and an image processing program.

Next, detailed description will be given of a configuration of the detection unit 220 according to the second exemplary embodiment of the present invention.

FIG. 9 is a configuration diagram of the detection unit 220 according to the second exemplary embodiment of the present invention. As shown in FIG. 9, the detection unit 220 comprises two CCDs (CCD 203 and CCD 209), two lens units (lens unit 201 and lens unit 206), a visible light blocking filter 202, an infrared blocking filter 207, a color filter 208 and an interface unit 204. The detection unit 220 according to the second exemplary embodiment is different from the first exemplary embodiment in that it comprises another CCD 209, another lens unit 206, the infrared blocking filter 207 and the color filter 208.

Configurations are similar to the first exemplary embodiment in terms of the CCD 203, lens unit 201, visible light blocking filter 202 and interface unit 204.

The CCD 209 performs photoelectric conversion of brightness of light entering via the lens unit 206, the infrared blocking filter 207 and the color filter 208 to a quantity of electric charge. The CCD 209 has sensitivity in the visible light range.

The lens unit 206 has the same configuration as the lens unit 201.

The infrared blocking filter 207 eliminates most of infrared components of the light guided by the lens unit 206 to the CCD 209.

The color filter 208 restricts a wavelength of light entering a pixel of the CCD 209 to one of the wavelengths of red (R), green (G) and blue (B) for each of the pixels. The color filter 208 may be a generally available Bayer array filter.

Under the configuration described above, the CCD 203 captures an image outside the visible light range (infrared range) similarly to the first exemplary embodiment, and the CCD 209 captures a color image in the visible light range.

Although the configuration where the two CCDs share one interface unit is shown in FIG. 9, it is alternatively possible to employ a configuration where two camera modules each including both of a CCD and an interface unit are arranged together. As such a camera module, a generally available CameraLink camera and an IEEE1394 camera may be used.

Next, operation of the input device 12 in FIG. 8 will be described in detail with reference to drawings.

The light source unit 100 injects light outside the visible light range from a side surface of the transparent paintable body 300.

The detection unit 220 continuously captures an image outside the visible light range and a color image in the visible light range, of the transparent paintable body 300 and painting substance adhering to it. The detection unit 220 captures the images at a rate of, for example, 60 frames per second.

When the painting substance 500 is not applied on the transparent paintable body 300, similarly to the first exemplary embodiment, light emitted from the light source unit 100 does not reach the detection unit 220. An image outside the visible light range captured by the detection unit 220 becomes an almost entirely black image as represented by a captured image 800 in FIG. 10, for example. A dotted line on the captured image 800 indicates a contour of the transparent paintable body 300 (it does not appear on actual images, but is shown for convenience of description) . Due to lens distortion and keystone distortion, which will be described later, the contour of the transparent paintable body 300, which is originally rectangular, is photographed distortedly.

Next, description will be given of a case where the painting substance 500 is applied on the transparent paintable body 300.

Similarly to the first exemplary embodiment, an evanescent wave is diffused outside the transparent paintable body 300 as indicated with B in FIG. 6, and reaches the detection unit 220.

It is assumed that, for example, an alphabet letter “A” is drawn on the surface of the transparent paintable body 300 by the painting tool 400. In this case, an image outside the visible light range captured by the detection unit 220 becomes such as that represented by a captured image 802 in FIG. 10. A portion with a shape of “A” popping up in white is a portion of the transparent paintable body 300 where the painting substance 500 is applied. Here, a diffusivity of the painting substance 500 with respect to light outside the visible light range needs to be high enough to enable the detection unit 220 to discriminately detect two sorts of portions where the painting substance 500 is applied and does not adhere respectively.

On the other hand, a color image in the visible light range recorded by the detection unit 220 becomes such as that represented by a captured image 804 in FIG. 10. The captured image 804 in FIG. 10 shows a result of capturing a situation where an alphabet letter “A” is drawn on a transparent board with red ink and a person is standing behind the board. As shown on the captured image 804 in FIG. 10, the detection unit 220 photographs the person and the light source unit 100 and the like in addition to the red letter “A”. The detection unit 220 outputs the captured images to the processing unit 600.

Here, for convenience, further description will be given assuming that the detection unit 220 simultaneously captures an image outside the visible light range and a color image in the visible light range, and that the both images are simultaneously outputted to the processing unit 600. However, in terms of characteristics of the present invention, the two sorts of images need not be captured at the same time, and thus a configuration may be such that each image is outputted to the processing unit 600 at a time when its capture is completed. The capture intervals also need not be identical with each other, and a configuration may be such that, for example, an image outside the visible light range is captured at a rate of 60 frames per second and a color image in the visible light range is at 30 frames per second.

The processing unit 600 performs image processing including brightness adjustment and distortion correction. Further, the processing unit 600 determines an area where the painting substance 500 is applied and its color, that is, it determines pictures and letters drawn on the marker board and their colors.

FIG. 11 is a flow chart showing an example of image processing performed by the processing unit 600.

As shown in FIG. 11, at step S1, the processing unit 600 judges reception of images from the detection unit 220 (a set of an image outside the visible light range and a color image in the visible light range).

On judging that images have been received at step S1, the processing unit 600 performs a lens distortion correction process at step S2. The lens distortion is a phenomenon in which, due to an optical characteristic of a lens unit, a straight side of an object or the like is distortedly captured as a curved line; it occurs especially remarkably when a wide-angle lens is used. The lens distortion correction process is a process for eliminating the lens distortion. With respect to a correction method of lens distortion, its detail description is given, for example, in non-patent document 2.

A captured image 806 in FIG. 12 is a diagram showing a result of a lens distortion correction process performed on the captured image 802 in FIG. 10 by the processing unit 600. As shown on the captured image 806 in FIG. 12, even after the elimination of curving distortion in the lens distortion correction process, the contour of the transparent paintable body 300, which is originally rectangular, still has a trapezoid-like shape. The trapezoid-like shape results from influence of a phenomenon called keystone distortion, which occurs due to that the detection unit 220 captures an image of the transparent paintable body from above the body.

At step S3, the processing unit 600 performs a keystone distortion correction process for eliminating keystone distortion. With respect to a correction method of keystone distortion, its detail description is given, for example, in non-patent document 3.

A captured image 808 in FIG. 12 is a diagram showing a result of a keystone distortion correction process performed on the captured image 806 in FIG. 12 by the processing unit 600.

On the other hand, also on the color image in the visible light range, the processing unit 600 similarly performs the lens distortion correction process and keystone distortion correction process In general, optical characteristics of a lens behave differently between in the visible light range and in another wavelength range (an infrared range, for example). Accordingly, even when lenses of the same type are used, a degree of lens distortion is different between them. Further, as shown in FIG. 9, the CCD for capturing an image outside the visible light range and the CCD for capturing an color image in the visible light range are arranged at slightly different positions, and hence a manner of keystone distortion generation is also slightly different between them. Accordingly, with respect to the lens distortion correction process and keystone distortion correction process for color images in the visible light range, own correction function and projective transformation, which are different from that used in the processes for images outside the visible light range, need to be obtained in advance.

A captured image 810 in FIG. 12 is a diagram showing a result of the lens distortion correction process and keystone distortion correction process performed on a color image represented as the captured image 804 in FIG. 10.

At step S4, the processing unit 600 performs a drawing content determination process. The drawing content determination process is a process of determining an area on the transparent paintable body 300 where the painting substance 500 is applied and its color, from the image outside the visible light range and the color image in the visible light range both of which have been subjected to the distortion corrections as described above. That is, the drawing content determination process is a process of determining pictures and letters drawn on the transparent marker board and their colors. The processing unit 600 may perform any process which enables determination of pictures and letters drawn on the transparent marker board and their colors.

FIG. 13 is a diagram for illustrating the drawing content determination process performed by the processing unit 600 in the second exemplary embodiment of the present invention. As shown in FIG. 13, in the present exemplary embodiment, the processing unit 600 executes an AND operation between a pixel of the image outside the visible light range having been subjected to the distortion corrections and a corresponding pixel of the color image in the visible light range also having been subjected to the distortion corrections, for each pixel of the images. For example, when the processing unit 600 performs this process on the images represented as the captured images 808 and 810 in FIG. 12, images in the background portion are eliminated and, such as on a captured image 812 in FIG. 12, pictures and letters drawn on the transparent marker board and their colors are determined. The processing unit 600 outputs the processed image to the storage device 20.

The storage device 20 records images outputted from the detection unit 600 as a motion picture continuously, or as still images at the times specified by the user.

As has been described above, the input device 12 according to the second exemplary embodiment makes it possible to detect color information of letters and figures on the transparent paintable body 300, as the detection unit 220 captures color images including the letters and figures on the transparent paintable body 300. In the processing unit 600, as position information and color information acquired by the detection unit 220 are processed to generate one image, it is possible to make conversion of pictures and letters drawn on the transparent marker board into electronic data, separating them from background.

### Third Exemplary Embodiment

Next, a third exemplary embodiment of an input device according to the present invention will be described.

An input device according to the third exemplary embodiment of the present invention is different, compared to the input device 12 according to the second exemplary embodiment, in a configuration of a detection unit. Configurations and operation of other portions than the detection unit are similar to the input device 12 according to the second exemplary embodiment.

A detection unit 240 according to the third exemplary embodiment captures both an image outside the visible light range and a color image in the visible light range with a single CCD.

FIG. 14 is a diagram showing an example of a configuration of the detection unit 240 according to the third exemplary embodiment. As shown in FIG. 14, the detection unit 240 comprises an extended color filter 210, a lens unit 211, a CCD 212 and an interface unit 204.

The extended color filter 210 is a device for restricting a wavelength of light entering a pixel of the CCD 212 to one of the wavelengths of red (R), green (G) and blue (B) for each of the pixels. The extended color filter 210 may be configured, as shown in FIG. 5, by substituting half of green filters in a Bayer array color filter with visible light blocking filters. The detection unit 240 according to the present exemplary embodiment acquires an image outside the visible light range and a color image in the visible light range simultaneously in one time capturing by the use of a single CCD and a single lens unit.

As has been described above, the input device 12 according to the third exemplary embodiment make it possible to obtain the same effect as the second exemplary embodiment with less number of components, by configuring the detection unit 240 with a single CCD and a single lens unit.

As described before, optical characteristics of a lens generally shows different behavior between in the visible light range and in another wavelength range (an infrared range, for example). As a result, a focal length of a lens is generally different between the visible light range and another wavelength range. Therefore, it is generally difficult for a single lens unit to focus on both images in the respective wavelength ranges. In the present invention, detection accuracy of color information is not so important compared to that on positions where the painting substance 500 is applied. Accordingly, focus may be adjusted to an image outside the visible light range.

### Fourth Exemplary Embodiment

Next, a fourth exemplary embodiment of an input device according to the present invention will be described.

An input device according to the fourth exemplary embodiment of the present invention is configured such that a way of its light source unit's injecting light to the transparent paintable body 300 is different compared to the input device 10 according to the first exemplary embodiment. Configurations and operation of other portions than the light source unit are similar to the input device 10 according to the first exemplary embodiment.

FIG. 16 is a diagram showing an example of a configuration of a light source unit 120 according to the fourth exemplary embodiment. As shown in FIG. 16, a light source unit 120 according to the present exemplary embodiment comprises one or more infrared LEDs 106, which are arranged in a line and driven by a power supply circuit 102 and a driving circuit 104, and a three-dimensional waveguide unit 108.

The three-dimensional waveguide unit 108 is made of a material having a refractive index almost identical with that of the transparent paintable body 300. The three-dimensional wave guide unit 108 has a configuration in which light emitted from the LEDs are guided into the inside of the board from a direction normal to the board surface. The three-dimensional waveguide unit 108 may be a triangular prism-like transparent body having a refractive index identical with that of the transparent board.

FIG. 17 is a diagram schematically illustrating how light emitted by the light source unit 120 is guided into the inside of the transparent board and propagates being confined inside the board.

As shown in FIG. 17, in order that light guided into the inside of the board satisfies a total reflection condition and thus propagates being confined inside the board, it is required that the light's incident angle at a boundary surface between the three-dimensional waveguide unit 108 and the transparent paintable body 300 (angle of the light beam with respect to a normal of the boundary surface) is equal to or larger than a critical angle θc.

FIG. 18 is a diagram showing an example of a section of the three-dimensional waveguide unit 108.

In FIG. 18, α is an angle of a vertex, of the three-dimensional waveguide unit 108, which is not in contact with the transparent board. When the half viewing angle of the infrared LEDs is represented by θ o, most portion of light emitted from the infrared LEDs has incident angles ranging θ s˜θ t at the boundary surface between the three-dimensional waveguide unit and the transparent paintable body. Simple geometric calculation gives θ s=90−θ o and θ t=2α−θ o−90. For example, when assuming θ o=15, θ s=75 and θ t=2α−105 are obtained. When the refractive index of the transparent paintable body 300 (and also of the three-dimensional waveguide unit 108) is assumed as 1.5, critical angle θ c=a sin (1/1 .5)=41.8 is obtained, and accordingly, if assuming α>73.4, θ s and θ t exceed the critical angle. In this situation, most portion of light emitted from the infrared LEDs propagates being confined inside the transparent board.

Here, the three-dimensional waveguide unit 108 needs to be arranged in close contact with the transparent paintable body 300. For this purpose, it may be clamped using a sucker or the like, applying matching oil having the same refractive index as the both bodies, or applying some other treatment like that, to the boundary surface.

Further, aluminum or the like may be evaporated partly or wholly on surfaces of the three-dimensional waveguide unit 108 except its surface in contact with the transparent paintable body 300 to form mirrors. The mirrors formation enables the three-dimensional waveguide unit 108 to guide more portion of light emitted from the light source unit 120 to the transparent paintable body.

Although an example in which all surfaces of the three-dimensional waveguide unit 108 are flat has been shown in the above description, some surfaces of the three-dimensional waveguide unit 108 may be formed as a curved surface.

As has been described above, according to the input device of the fourth exemplary embodiment, light emitted by the light source unit 120 can be propagated being confined inside the transparent paintable body 300 even when the transparent paintable body 300 is difficult to access at its end surfaces, such as when an already-installed pane of window glass is used as the transparent paintable body 300.

### Fifth Exemplary Embodiment

Next, a fifth exemplary embodiment of an input device according to the present invention will be described.

An input device according to the fifth exemplary embodiment of the present invention is different compared to the input device 12 according to the second exemplary embodiment in a configuration of a light source unit. Configurations and operation of other portions than the light source unit are similar to the input device 12 according to the second exemplary embodiment.

A light source unit 140 according to the fifth exemplary embodiment generates white light in addition to light outside the visible light range.

FIG. 19 is a diagram showing an example of a configuration of the light source unit 140 of the fifth exemplary embodiment. As shown in FIG. 19, the light source unit 140 according to the fifth exemplary embodiment comprises one or more infrared LEDs and white LEDs which are arranged alternately in a line and driven by a power supply circuit 102 and a driving circuit 104.

The white LEDs are light emitting devices which emit light of wavelength spectrum over the whole visible light range. Visible light emitted from the white LEDs of the light source unit 140 propagates being confined inside the transparent paintable body 300 and diffused outside by the painting substance 500, similarly to light outside the visible light range. The detection unit 200 captures the diffused visible light as a color image.

As it has been described above, according to the input device of the fifth exemplary embodiment, as the light source unit 140 comprises white LEDs in addition to infrared LEDs, it is possible to detect color information of letters and figures on the transparent paintable body 300 even in a situation such as where lighting is switched off in a room where an input device of the present invention is installed. Therefore, according to the input device of the fifth exemplary embodiment, it is possible to make conversion of pictures and letters drawn on the transparent marker board into electronic data, separating them from background, in broader range of lighting conditions.

### Sixth Exemplary Embodiment

FIG. 20 is a block diagram of an input device 14 according to a sixth exemplary embodiment of the present invention. FIG. 21 is a configuration diagram of the input device 14 according to the sixth exemplary embodiment of the present invention. As shown in FIGS. 20 and 21, the input device 14 is different from the input device 12 according to the second exemplary embodiment in that it further comprises a synchronization control unit 700. Additionally, the input device 14 is different compared to the input device 12 according to the second exemplary embodiment in that its light source unit has only white LEDs and its detection unit captures only color images in the visible light range. Further, in the input device 14, a determination process performed by a processing unit is different compared to the input device 12 according to the second exemplary embodiment.

The synchronization control unit 700 controls a light source unit 160 and a detection unit 260 to capture images in two states where light is injected and not injected, respectively, into the transparent paintable body 300.

FIG. 22 is a diagram specifically illustrating a light source unit 160, a detection unit 260 and a synchronization control unit 700 according to the sixth exemplary embodiment of the present invention.

The light source unit 160 comprises a power supply circuit 102, a driving circuit 104 and white LEDs 110. In the present exemplary embodiment, the light source unit 160 comprises no infrared LED and generates only visible light. Controlled by the synchronization control unit 700, the light source unit 160 repeats ON and OFF states where visible light is generated and not generated, respectively.

As shown in FIG. 23, the detection unit 260 comprises a color filter 208, a lens unit 213, a CCD 214 and an interface unit 204. The CCD 214 photoelectrically converts brightness of light entering it via the lens unit 213 and the color filter 208 into a quantity of electric charge. The CCD 214 has sensitivity in the visible light range. The lens unit 213 is configured similarly to the lens unit 201 and the like. The color filter 208 is configured similarly to the color filter 208 in the second exemplary embodiment.

The synchronization control unit 700 is an electronic circuit comprising a microcontroller 702 and a clock oscillator 704. The synchronization control unit 700 generates a specific control signal for each of the light source unit 160 and the detection unit 260 (a light source unit control signal and a detection unit control signal) with an optional time schedule. One of the outputs of the synchronization control unit 700 (light source unit control signal) is connected to the driving circuit 104 of the light source unit 160. When the control signal is in a High state, the light source unit 160 applies an electric current through the white LEDs. The other output of the synchronization control unit 700 (detection unit control signal) is connected to an external trigger terminal of the detection unit 260. When the control signal is in a High state, the detection unit 260 executes an exposure. Here, the synchronization control unit 700 may be arranged as an independent circuit or built-in in the light source unit 160 or in the detection unit 260.

Next, description will be given of operation of the input device 14 focusing on a portion different from the second exemplary embodiment.

FIG. 24 is a diagram representing a square wave pulse of a control signal outputted from the synchronization control unit 700. As shown in FIG. 24, the synchronization control unit 700 outputs a square wave pulse with a constant period, for example, 60 frames per second, to the detection unit 260. Further, the synchronization control unit 700 outputs to the light source unit 160 a square wave pulse with a period which is half that of the square wave pulse outputted to the detection unit 260. As a result, the detection unit 260 captures an image of a state where the light source unit 160 is on and an image of a state where the light source unit 160 is off, alternately.

Light emitted from the white LEDs of the light source unit 160 propagates inside the transparent paintable body 300, is diffused outside by the painting substance 500 and then detected by the detection unit 260. Therefore, positions where the painting substance 500 is applied appear brighter on an image of a state where the light source unit 160 is on, compared to on an image of a state where the light source unit 160 is off.

FIG. 25 is a diagram showing an example of each of the two sorts of images respectively captured when the light source unit 160 is on and off. A captured image 814 in FIG. 25 represents an image captured when the light source unit 160 is on. A captured image 816 in FIG. 25 represents an image captured when the light source unit 160 is off.

The processing unit 620 according to the sixth exemplary embodiment performs, as a first step, correction processes for lens distortion and keystone distortion, similarly to the second exemplary embodiment, on an image of when the light source unit 160 is on and that of when the light source unit 160 is off. Here, as both of the images are captured in the visible light range using an identical lens, the processing unit 620 uses a correction function for lens distortion correction and a projective transformation for keystone distortion which are common to the ON and OFF states.

Next, the processing unit 620 performs a drawing content determination process which is a process for determining colors of pictures and letters drawn on the marker board. FIG. 26 is a diagram for illustrating a drawing content determination process performed by the processing unit 620 in the sixth exemplary embodiment of the present invention.

In the drawing content determination process, as a first step, the processing unit 620 performs monochrome conversion of consecutive two images which are captured when the light source unit 160 is on and off, respectively. Next, the processing unit 620 calculates an image difference between the two images. If a frequency of the detection unit 260 is set at an appropriate value, there exists almost no change in states of background and ambient light between the images. Accordingly, by calculating the image difference, the processing unit 620 generates an image which enables detection of positions where the painting substance is applied, similarly to, for example, the captured image 808 in FIG. 12.

Then, the processing unit 620 performs AND operation between the generated image and either of the images captured when the light source unit 160 is on and off, respectively. By performing the AND operation, the processing unit 620 determines pictures and letters drawn on the marker board and their colors, similarly to the captured image 812 in FIG. 12.

As has been described above, according to the input device of the sixth exemplary embodiment, adhering positions and colors of the painting substance can be determined directly from a difference between a capture result of when the light source is emitting light and that of when the light source is not emitting light. It is because the detection unit 260 captures images in synchronization with light emission of the light source unit 160 under control of the synchronization control unit 700.

### Seventh Exemplary Embodiment

Except for some portions, a configuration of an input device according to a seventh exemplary embodiment of the present invention is similar to the input device 14 according to the sixth exemplary embodiment. In the input device according to the seventh exemplary embodiment of the present invention, a configuration of a light source unit is different, compared to the input device 14 according to the sixth exemplary embodiment. Also different is a determination process performed by a processing unit. In the following, description will be given focusing on a difference from the sixth exemplary embodiment.

FIG. 27 is a diagram specifically representing a light source unit 180, a detection unit 260 and a synchronization control unit 700 according to the seventh exemplary embodiment of the present invention.

The light source unit 180 comprises a power supply circuit 102, a driving circuit 104 and infrared LEDs 106. Controlled by the synchronization control unit 700, the light source unit 180 repeats ON and OFF states where infrared light is generated and not generated, respectively. When a control signal generated by the synchronization control unit 700 is in the High state, the light source unit 180 applies an electric current through the infrared LEDs 106.

Next, description will be given of operation of the input device of the seventh exemplary embodiment of the present invention, focusing on a portion different from the sixth exemplary embodiment.

A square wave pulse outputted from the synchronization control unit 700 is represented by FIG. 24 similarly to the sixth exemplary embodiment.

Light emitted from the infrared LEDs of the light source unit 180 propagates inside the transparent paintable body 300, is diffused outside by the painting substance 500 and then detected by the detection unit 260. Therefore, on an image of a state where the light source unit 180 is on, positions where the painting substance 500 is applied are captured as bright.

FIG. 28 is a diagram showing an example of each of two sorts of images respectively captured when the light source unit 180 according to the seventh exemplary embodiment of the present invention is on and off. A captured image 818 in FIG. 28 represents an image captured when the light source unit 180 is on. A captured image 820 in FIG. 28 represents an image captured when the light source unit 180 is off. In a state where the light source unit 180 is off, light scattered by the painting substance 500 is not detected, and only infrared light emitted from surrounding environment other than the light source unit 180 is detected. Typical sources of infrared light emitted from surrounding environment are sunlight, a fluorescent lamp just after power on and the like.

The processing unit 640 according to the seventh exemplary embodiment performs, as a first step, correction processes for lens distortion and keystone distortion, similarly to the second exemplary embodiment, on an image of when the light source unit 180 is on and that of when the light source unit 180 is off. Here, as both of the images are captured in the infrared light range using an identical lens, the processing unit 640 uses a correction function for lens distortion correction and a projective transformation for keystone distortion which are common to the ON and OFF states.

Next, from the two images, the processing unit 640 calculates positions of pictures and letters drawn on the marker board. The processing unit 640 calculates an image difference between consecutive two images which are captured when the light source unit 180 is on and off, respectively. If a frequency of the detection unit 260 is set at an appropriate value, there exists almost no change in the state of infrared light emitted from surrounding environment between the images. Accordingly, by calculating the image difference, the processing unit 620 generates an image which enables detection of positions where the painting substance 500 is applied, similarly to, for example, the captured image 808 in FIG. 12.

As has been described above, according to the input device of the seventh exemplary embodiment, adhering positions of the painting substance can be determined directly from a difference between a capture result of when a light source is emitting light and that of when the light source is not emitting light. As a result, direct detection of an ink distribution state on the maker board surface is possible even in a situation where infrared light sources, such as sunlight and a fluorescent lamp just after power on, are present in surrounding environment Further, according to the input device 14 of the seventh exemplary embodiment, as a difference between an image captured with the light unit on and that captured with the light unit off is generated using infrared light which is invisible to the human eye, generation of a flicker at adhering positions of the painting substance is prevented, compared to the sixth exemplary embodiment.

### Eighth Exemplary Embodiment

Except for some portions, a configuration of an input device according to an eighth exemplary embodiment of the present invention is similar to the input device according to the seventh exemplary embodiment. Compared to the input device according to the seventh exemplary embodiment, the input device according to the eighth exemplary embodiment of the present invention is different in that its detection unit detects a total of intensity of light in the visible light range and that of light outside the visible light range. Additionally, in the input device according to the eighth exemplary embodiment, a determination process performed by a processing unit is different compared to the input device according to the seventh exemplary embodiment.

As shown in FIG. 23, a detection unit 260 according to the eighth exemplary embodiment comprises a color filter 208, a lens unit 213, a CCD 214 and an interface unit 204. The CCD 214 photoelectrically converts brightness of light entering it via the lens unit 213 and the color filter 208 into a quantity of electric charge. The CCD 214 has sensitivity in both the visible and infrared light ranges. The lens unit 213 is configured similarly to the lens unit 201 and the like. As shown in FIG. 29, while the color filter 208 restricts a wavelength of light entering a pixel of the CCD 214 to one of wavelengths of red (R), green (G) and blue (B) for each of the pixels, it transmits most of infrared light with respect to all pixels of the CCD 214. There are relatively a large number of color filters showing such a characteristic, and they are sometimes used in combination with a separate infrared light blocking filter, because it is not desirable to transmit infrared light in particular uses.

The detection unit 260 according to the eighth exemplary embodiment detects total intensity of visible light and infrared light entering each pixel of the CCD 214.

Next, description will be given of operation of the input device of the eighth exemplary embodiment of the present invention, focusing on a portion different from the seventh exemplary embodiment.

Light emitted from the infrared LEDs of the light source unit 180 propagates inside the transparent paintable body 300, is diffused outside by the painting substance 500 and then detected by the detection unit 260. Therefore, positions where the painting substance 500 is applied appear brighter on an image of a state where the light source unit 180 is on, compared to on an image of a state where the light source unit 180 is off.

FIG. 25 is a diagram showing an example of each of two sorts of images respectively captured when the light source unit 180 is on and off. A captured image 814 in FIG. 25 represents an image captured when the light source unit 180 is on. A captured image 816 in FIG. 25 represents an image captured when the light source unit 180 is off.

The processing unit 660 according to the eighth exemplary embodiment performs, as a first step, correction processes for lens distortion and keystone distortion, similarly to the second exemplary embodiment, on an image of when the light source unit 180 is on and that of when the light source unit 180 is off. Here, as both of the images are captured using an identical lens, the processing unit 660 uses a correction function for lens distortion correction and a projective transformation for keystone distortion which are common to the ON and OFF states.

Next, the processing unit 660 performs a drawing content determination process for determining pictures and letters drawn on the marker board and their colors. FIG. 30 is a diagram for illustrating a drawing content determination process performed by the processing unit 660 in the eighth exemplary embodiment of the present invention.

In the drawing content determination process, as a first step, the processing unit 660 performs monochrome conversion of consecutive two images which are captured when the light source unit 180 is on and off, respectively. Next, the processing unit 660 calculates an image difference between the two images, by calculating a difference between a total intensity of light detected when the light source unit is on and that detected when the light source unit is off. If a frequency of the detection unit 260 is set at an appropriate value, there exists almost no change in states of background and ambient light between the two images. Accordingly, by calculating the image difference, the processing unit 660 generates, an image which enables detection of positions where the painting substance is applied, similarly to, for example, the captured image 808 in FIG. 12. As a result of the calculation of the difference, the processing unit 660 determines a spot with a larger light intensity difference than a threshold value as a position where the painting substance is applied.

Then, the processing unit 660 performs AND operation between the generated image and the image captured when the light source unit 180 is off. By performing the AND operation, the processing unit 660 determines pictures and letters drawn on the marker board and their colors, similarly to the captured image 812 in FIG. 12. Here, the image of when the light source 180 is off needs to be used as the image subjected to the AND operation with the generated image. It is because, on the image of when the light source unit 180 is on, areas covered with ink are captured as almost entirely white, resulting from detection of relatively intensive infrared light at every pixel assigned as a pixel of red (R), green (G) or blue (B).

As has been described above, according to the input device of the eighth exemplary embodiment, adhering positions and colors of applied painting substance can be detected using a single CCD, from a difference between a capture result of when the light source is emitting light and that of when the light source is not emitting light. Further, in the present configuration, a generally available color filter can be used, with no necessity of a special color filter such as an extended color filter. In addition, according to the input device of the seventh exemplary embodiment, as a difference between an image captured with the light unit on and that captured with the light unit off is generated using infrared light which is invisible to the human eye, generation of a flicker at positions where the painting substance is applied is prevented, similarly to the seventh exemplary embodiment.

### Ninth Exemplary Embodiment

FIG. 31 is a configuration diagram of an input device 16 according to a ninth exemplary embodiment of the present invention. As shown in FIG. 31, the input device 16 according to the ninth exemplary embodiment of the present invention is different from the input device 12 according to the second exemplary embodiment in that a transparent paintable body is a film-like transparent paintable body which can be pasted to a base member such as a glass surface. In the present exemplary embodiment, a feature exists in a structure of transparent paintable body, and other configurations and operation are similar to the input device 12 according to the second exemplary embodiment.

A transparent paintable body 320 according to the ninth exemplary embodiment has a structure in which a core layer capable of guiding light inside and a clad layer with a refractive index lower than that of the core layer are stacked on top of another.

FIG. 32 is a cross-sectional view of a transparent paintable body 320 according to the ninth exemplary embodiment of the present invention. As shown in FIG. 32, the film-like transparent paintable body 320 comprises a core layer 302, a clad layer 304 and an adhesive layer 306.

The core layer 302 confines and guides light emitted from the light source unit 100. The core layer 302 may have a tapered structure in which the thickness gradually decreases so as to further ease guiding of light from the light source unit 100 into the core layer. The clad layer 304 totally reflects light emitted from the light source unit 100 at the boundary surface with the core layer 302. The core layer 302 and the clad layer 304 may be made from resin films, such as PET (polyethylene terephthalate), with additives added to adjust a refractive index. Here, with respect to a refractive index of the core layer 302 (ncore) and that of the clad layer 304 (nclad), ncore>nclad is required so as to satisfy a total reflection condition.

The adhesive layer 306 sticks the film-like transparent paintable body 320 to the base member. The adhesive layer 306 may be a general adhesive for resin films or a silicone rubber film. The adhesive layer 306 may be of a type having a stress relaxation function so that light from the light source unit 100 does not unnecessarily diffuse outside due to distortion of the core layer 302 and clad layer 304 (micro-bending) induced by a stress.

Operation of the input device according to the ninth exemplary embodiment is similar to the second, sixth, seventh or eighth exemplary embodiment. Light emitted from the light source unit is propagated being confined inside the film-like transparent paintable body 320, and is diffused by the painting substance 500. By detecting the diffused light, the detection unit detects positions of the painting substance 500. Then, the processing unit determines drawn pictures and letters and outputs the results to the storage device 20.

As has been described above, according to the input device of the ninth exemplary embodiment, because of the use of the film-like transparent paintable body 320 which can be pasted to a transparent base member such as a glass surface, it is possible to make a pane of window glass or the like into a transparent marker board by pasting the film-like transparent paintable body 320 to it.

### Tenth Exemplary Embodiment

A tenth exemplary embodiment of the present invention is a database system which stores information on pictures, letters and the like which was converted to electronic data by an input device of the present invention in a secondary storage device such as a hard disk drive, and thus enables reuse of the information at a later date.

The present system comprises an input device and a storage device which have been described in any one of the first to ninth exemplary embodiments, and a display unit.

The storage device may be a secondary storage device for storing information on pictures, letters and the like, such as a hard disk drive.

The display unit displays the information on pictures, letters and the like stored in the storage device in response to the user's operation.

As has been described above, according to an input system of the tenth exemplary embodiment, it is possible to separate pictures and letters drawn on a transparent or semitransparent marker board from background, convert the drawn figures and letters to electronic data accurately, and store the data in a form it can be reused at a later date. Further, free browsing of the stored electronic data becomes possible.

### Eleventh Exemplary Embodiment

An eleventh exemplary embodiment of the present invention is a transfer system which transfers information on pictures, letters and the like which was converted to electronic data by an input device of the present invention to remote bases.

The present system comprises an input device described in any one of the first to ninth exemplary embodiments, and a transfer device and a display unit.

The transfer device delivers information on pictures, letters and the like converted to electronic data to remote location via a network. Further, in addition to the information on pictures, letters and the like, the transfer device may transfer either or both of video and sound recorded at a space where the input device is installed to remote locations.

The display unit displays the information on pictures, letters and the like delivered by the transfer device at a remote location.

As has been described above, according to the transfer system of the eleventh exemplary embodiment, it is possible to separate pictures and letters drawn on a transparent or semitransparent marker board from background, convert the drawn figures and letters to electronic data, transfer the data to remote locations, and accordingly use the data for communication between remote bases.

Although the present invention has been described above with reference to exemplary embodiments, the present invention is not limited to the above exemplary embodiments. Various changes and modifications which are understood by those skilled in the art may be made in the configurations and details of the present invention, within the scope of the present invention.

This application insists on priority based on Japanese Patent Application No. 2009-212711 proposed on Sep. 15, 2009 and takes everything of the disclosure here.

### Reference Signs List

10 input device according to the first exemplary embodiment

12 input device according to the second exemplary embodiment

14 input device according to the sixth exemplary embodiment.

16 input device according to the ninth exemplary embodiment

20 storage device

100 light source unit according to the first exemplary embodiment

120 light source unit according to the fourth exemplary embodiment

140 light source unit according to the fifth exemplary embodiment

160 light source unit according to the sixth exemplary embodiment

180 light source unit according to the seventh and eighth exemplary embodiments

200 detection unit according to the first exemplary embodiment

220 detection unit according to the second exemplary embodiment

240 detection unit according to the third exemplary embodiment

260 detection unit according to the sixth and eighth exemplary embodiments

300 transparent paintable body according to the first exemplary embodiment

320 transparent paintable body according to the ninth exemplary embodiment

400 painting tool

500 painting substance

600 processing unit according to the second exemplary embodiment

620 processing unit according to the sixth exemplary embodiment

640 processing unit according to the seventh exemplary embodiment

660 processing unit according to the eighth exemplary embodiment

700 synchronization control unit

102 power supply circuit

104 driving circuit

106 infrared LED

108 three-dimensional waveguide unit

110 white LED

201 lens unit

202 visible light blocking filter

203 CCD

204 interface unit

205 connection cable

206 infrared blocking filter

207 infrared blocking filter

208 color filter

209 CCD

210 extended color filter

211 lens unit

212 CCD

213 lens unit

214 CCD

302 core layer

304 clad layer

306 adhesive layer

702 microcontroller

704 clock oscillator

800 captured image

802 captured image

804 captured image

806 captured image

808 captured image

810 captured image

812 captured image

814 captured image

816 captured image

818 captured image

820 captured image

1. An input device comprising:
a light source unit which injects light into a transparent or semitransparent paintable body in a manner the light is guided inside said paintable body; and
a detection unit which detects light diffused out of said paintable body by applying painting substance on a surface of said paintable body.

2. The input device according to claim 1 further comprising
a processing unit which determines an area where intensity of light detected by said detection unit is higher than a threshold value as an area where said painting substance is applied.

3. The input device according to claim 1 further comprising:
a synchronization control unit which controls said light source unit and said detection unit to detect respective light intensities in states where light is injected and not injected into said paintable body; and
a processing unit which calculates a difference between said respective light intensities and determines an area where the difference is larger than a threshold value as an area where said painting substance is applied.

4. The input device according to claim 2, wherein
said processing unit determines a color of said painting substance, on the basis of a detection result from said detection unit.

5. The input device according to claim 4, wherein:
light injected by said light source unit includes light outside the visible light range;
said detection unit includes a first light detection section for detecting light outside the visible light range and a second light detection section for detecting light in the visible light range; and
said processing unit determines an area where said painting substance is applied, on the basis of a detection result from said first light detection section, and determines a color of said painting substance, on the basis of a detection result by said second light detection section.

6. The input device according to claim 4, wherein:
light injected by said light source unit includes light outside the visible light range;
said detection unit includes an element for restricting an wavelength of light to be detected to either a specific wavelength range in the visible light range or an wavelength range outside the visible light range; and
said processing unit determines an area where said painting substance is applied, on the basis of a detection result of light whose wavelength is restricted to an wavelength range outside the visible light range by said element, and determines a color of said painting substance, on the basis of a detection result of light whose wavelength is restricted to a specific wavelength range in the visible light range by said element.

7. The input device according to claim 3, wherein:
light injected by said light source unit includes light outside the visible light range;
said detection unit detects a combined intensity of light in a specific wavelength range within the visible light range and of light outside the visible light range; and
said processing unit determines an area where said calculated difference in light intensities, which is a difference between said combined intensities of light when the light from said light source unit is injected and of light when light from said light source unit is not injected, is larger than a threshold value as an area where said painting substance is applied, and determines a color of said painting substance on the basis of a detection result in said state where light is not injected.

8. The input device according to claim 5, wherein
said light outside the visible light range is infrared light.

9. The input device according to claim 5, wherein
light injected by said light source unit further includes visible light.

10. The input device according to claim 3, wherein:
light injected by said light source unit is visible light;
said detection unit detects, in the visible light range, respective light intensities in a state where light is injected into said paintable body and in a state where light is not injected; and
said processing unit determines an area where said calculated difference in light intensity is larger than a threshold value as an area where said painting substance is applied, and determines a color of said painting substance on the basis of either of respective detection results in said state where light is injected or in said state where light is not injected.

11. The input device according to claim 1, wherein
said light source unit includes a three-dimensional waveguide unit in close contact with a surface of said paintable body for guiding light into said paintable body.

12. The input device according to claim 1, wherein
said paintable body has a structure where a core layer capable of guiding light inside and a clad layer with a refractive index lower than that of the core layer are stacked on top of another.

13. The input device according to claim 12, wherein
at least a portion of said paintable body has a structure where an adhesive layer capable of sticking to another body is further stacked contiguously to the clad layer.

14. An input system comprising:
an input device comprising:
a paintable body which is transparent or semitransparent and is capable of guiding light inside,
a light source unit which injects light in a manner the light is guided inside said paintable body, and
a detection unit which detects light diffused out of said paintable body by applying painting substance on a surface of said paintable body;
a recording unit which is connected to said input device and stores a position of said painting substance as electronic data, on the basis of a detection result from said detection unit; and
a display unit which displays said position of said painting substance which is stored in said recording unit.

15. The input system according to claim 14 further comprising
a transfer device which is connected to said input device and transfers said position of said painting substance to a remote location via a network.

16. The input system according to claim 12, wherein
said transfer device further transfers either or both of video and sound recorded at a space where said input devices is installed to a remote location.

17. An input method comprising:
injecting light into a transparent or semitransparent paintable body in a manner the light is guided inside said paintable body; and
detecting light diffused out of said paintable body by applying painting substance on a surface of said paintable body.

18. A strage medium for storing an input program for enabling a computer to execute:
a step of injecting light into a transparent or semitransparent paintable body capable of guiding light inside; and
a step of detecting light diffused out of said paintable body from painting substance being applied on a surface of said paintable body.

19. The input device according to claim 3, wherein
said processing unit determines a color of said painting substance, on the basis of a detection result from said detection unit.

20. The input device according to claim 6, wherein
said light outside the visible light range is infrared light.
